(19) United States
(12) Patent Application Publication
(10) Pub. No.: US 2005/0129826 A1
(43) Pub. Date: Jun. 16, 2005

(54) Method for the treatment of shredded cheese with a polyene antifungal compound

(76) Inventors: Martinus Johannes Maria Warmerdam, Rijswijk (NL); Ben Rudolf Haan De, Voorburg (NL)

Correspondence Address: MORRISON & FOERSTER LLP, 3811 VALLEY CENTRE DRIVE, SUITE 500, SAN DIEGO, CA, 92130-2332, US

(21) Appl. No.: 10/516,663

(22) PCT Filed: May 28, 2003
(86) PCT No.: PCT/EP03/05725

(30) Foreign Application Priority Data
Jun. 3, 2002 (EP) 021006622

(51) Int. Cl. A23C 19/00

(52) U.S. Cl. 426/582

(57) ABSTRACT

A method for the treatment of shredded cheese with an aqueous composition whereby the aqueous composing comprises a polyene antifungal compound e.g. notamycine and a thickening agent, e.g. xanthan. Use of a thickening agent to prevent nozzle clogging during the treatment of food, feed and agricultural products with an aqueous composition.

### FIELD OF THE INVENTION

The present invention relates to a method for the treatment of shredded cheese with a polyene antifungal compound.

### BACKGROUND OF THE INVENTION

The prevention of mould growth is an important topic to the food, feed and. agricultural industry, especially in the food industry. Fungal spoilage can lead to serious economic losses. Some foods can be considered as a good substrate for fungal growth. Cheese is an example of such a product. Apart from the negative appearance of fungal growth on cheese, fungal spoilage is also a health risk. Some mould species produce mycotoxins, which may penetrate into the product (J. C. Frisvad & U. Thane; “Mycotoxin production by food-borne fungi” in Introduction to food-borne fungi, 4^{th} edn. (ed. R. A. Samson et al.), 1995, 251-260. Therefore, superficial removal of moulds gives no guarantee of safety to the consumer.

For more than 30 years, natamycin has been used to prevent growth of moulds and yeasts on cheeses and sausages. Natamycin is on the market under the brand name of Delvocid®, a powder composition containing 50% (wlw) of natamycin.

Food products can be treated with natamycin in different ways. Natamycin can for example be added to the polymer dispersion that is applied to the cheese rind as a coating (C. B. G. Daamen & G. van den Berg “Prevention of mould growth on cheese by means of natamycin” Voedingsmiddelentechnologie, 1985, 18 (2), 26-29)

Alternatively, food products such as cheeses and sausages can be treated by dipping or spraying with a suspension of natamycin in water (C. B. G. Daamen & G. van den Berg “Prevention of mould growth on cheese by means of natamycin” Voedingsmiddelentechnologie, 1985, 18 (2), 26-29; H. A. Morris & H. B. Castberg “Control of surface growth on blue cheese using pimaricin” Cultured Dairy Products Journal, 1980, 15 (2), 21-23; P. Baldini, F. Palmia, R. G. Raczynski, M. Campanini, “Use of pimaricin for preventing mould growth on Italian cured meat products”, Industria Conserve, 1979, 54 (4), 305-307; R. A. Holley, “Prevention of surface mould growth on Italian dry sausage by natamycin and potassium sorbate”, Appl. Environ. Microbiol., 1981, 41 (2).

Spraying of a suspension of natamycin can be applied for the treatment of shredded cheese, a cheese product which is very sensitive to fungal spoilage. The production of shredded cheese is as follows: cheese, e.g. Mozarella, pizza cheese, or Cheddar is shredded and conveyed to a revolving tumbler. An anti-caking agent, for example cellulose (microcrystalline or powdered), starch or modified starch is metered onto the cheese in the first part of the tumbler. Cellulose forms a film around the cheese particles which prevents caking of the shredded cheese. At the end of the tumbler a suspension of natamycin (e.g. Delvocid®) is sprayed onto the shredded cheese. The spray nozzles deliver a fine spray or mist of the fungicide onto the cheese. Finally, the cheese empties onto a conveyor to be transported to the filling equipment.

The natamycin suspension is prepared by mixing Delvocid® and water, mostly at the ratio from 2 to 10 grams of Delvocid® to 1 litre of water. The suspension is stored in a liquid container. To prevent sedimentation of the suspension a small amount of the suspension, which is pumped under pressure to spray nozzles, is recirculated to the liquid container via a jet agitator. Alternatively, a stirring device can be used to prevent sedimentation. Mostly approximately 6 to 8 litres of Delvocid® suspension is sprayed onto 1000 kg of cheese. Mostly this treatment is effective to prevent fungal spoilage.

The spraying or showering of aqueous suspensions on cheeses using nozzles is an effective way of coating the cheeses with the antifungal compounds. In general a less fine spray is used for spraying of complete cheeses. This spray or shower will be focused or directed onto the cheese. However for spraying of shredded cheese, the suspension should be added as a fine spray or mist. This spraying method often gives rise to problems such as the clogging of the spraying nozzles.

### DESCRIPTION OF THE INVENTION

It now has been found that protection against the development of moulds and yeasts shredded cheese is obtained in a method for the treatment shredded cheese with a composition comprising a polyene antifungal compound, whereby the composition comprises a polyene antifungal agent, a thickening agent and water. Surprisingly it has been found that the thickening agent prevents the clogging of the nozzles. Moreover the aqueous composition can be pumped under pressure to and through the nozzles without problems which would have been expected due to the expected increase of viscosity of the aqueous composition of the invention compared to an aqueous composition without thickening agent. Especially xanthan gives very good results.

Therefore the present invention relates to a method for the treatment of shredded cheese with an aqueous composition whereby the aqueous composition comprises a polyene antifungal compound and a thickening agent. The present invention also relates to products produced with the present method. Shredded cheese coated with a polyene antifungal compound and thickening agent forms part of this invention. A thickening agent is used to prevent the nozzle clogging during the treatment of food, feed and agricultural products with an aqueous composition.

The polyene antifungal compounds used in the composition of the invention are preferably one or more of natamycin, nystatin, lucensomycin or amphotericin B. The preferred polyene compound is natamycin. In the preparation of compositions of the invention, one or more polyene antifungal compounds may be used or pre-prepared compositions containing such antifungal components may be used. An example of such a preparation is commercially available powder composition sold under the trade mark Delvocid® which contains 50% (w/w) natamycin.

The concentration of polyene fungicide in the aqueous composition will generally be from 0.1 to 20 g/l, more preferably from 0.5 to 8 g/l and most preferably from 1 to 5 g/l.

In compositions of the invention the preferred thickening agents include all thickening agents known in the art for use in food products, preferably the thickening agents are gum, more preferably xantan gum and/or gellan gum.

The one or more thickening agents in the aqueous composition are preferably present in an amount of 0.5 to 50 g/l, more preferably from 0.5 to 20 g/l and most preferably from 1 to 5 g/l.

In some embodiments it has been found that no buffer is needed for the suspension. In general the pH of the suspension will be between 3-10, preferably the pH will be between 6-9, more preferably between 6.2-8.5 for the optimal natamycin addition.

Preferably also an anticaking agent is added to the shredded cheese. The anticaking agent preferably is a dry powder composition, which is added separately from the aqueous composition. In general 0.2 to 3% w/w of anticaking agent (on shredded cheese) preferably between 1.5 and 2.5% w/w.

The steps of adding the dry powder composition and the aqueous composition may be performed in any order. Preferably, the dry powder composition is added before the aqueous composition is added.

The amount of the aqueous composition added to the shredded cheese may be between 0.01% and 5% (v/w), preferably said amount is at least 0.5% or preferably lower than 2% (v/w).

In a preferred embodiment, the aqueous composition used in the method according to the present invention is an aqueous solution or an aqueous dispersion such as an emulsion or suspension.

The optimal final concentration of natamycin added according to the method of the present invention, may vary with the type of cheese used as shredded cheese or the kind of shredded used. To prevent fungal growth on shredded cheese, the optimal final concentration may be between 2 and 40 ppm natamycin, preferably the concentration is at least 3 ppm natamycin, more preferably at least 4 ppm natamycin. The concentration is preferably lower than 20 ppm, more preferably lower than 10 ppm.

Any anti-caking agent may be used. Examples of suitable anti-caking agents are microcrystalline or powdered cellulose, starch, modified starch, sodium-, magnesium-, potassium-, and zinc silicate, silicium-dioxide, kaolin, talc, potassium and magnesium carbonate, phosphates (di, tri and polyphosphates including sodium, potassium and calcium salts). Also commercial products containing cellulose, such as Keycel or Floam® may be used as anti-caking agent. Further, any combination of anti-caking agents may be used.

The aqueous composition comprising an antifungal compound, e.g. natamycin, may be prepared by mixing a dry formulation, e.g. Delvocid®, in water using well known methods. Preferably a natamycin suspension for spraying is prepared by using a stock suspension of natamycin as described in EP 0 678 241. This stock suspension is a chemically, physically and microbially stable concentrated suspension of natamycin, which provides a convenient stock for the easy and reproducable dosage of a fungicide to food, feed and agricultural products. Apart from natamycin, the suspension comprises a thickening agent, for example xanthan. The concentration of natamycin in the stock suspension may be as high as 40% (w/w), however also stock suspensions with lower concentrations of natamycin can be used. An example of such a stock suspension is the commercial product Delvocid®-Sol. This product comprises at least 50% (w/w) of natamycin; for example 50 to 54% (w/w) of natamycin, 2% (w/w) of xanthan and 44 to 48% (w/w) of lactose. In the case of shredded cheese the stock suspension is diluted with water to the final concentration required for the treatment. This dilution step can be best executed just before adding the natamycin suspension to the shredded cheese.

In cases where the polyene antifungal compound is natamycin, complexes of natamycin (e.g. with proteins) and salts of natamycin (e.g. the calcium salt) may also be used in the method according to the present invention. Further, the dry and aqueous compositions may also contain components, which are already present in a natamycin preparation. For example, when Delvocid-Instant® or Natamax® is used, lactose will also be present in the final composition.

The following Examples are for illustrative purposes only and are not to be construed as being limiting to the invention.

### EXAMPLES

Cheddar cheese was shredded using well known methods and conveyed to a revolving tumbler. Microcrystalline cellulose was metered onto the shredded cheese in the first part of the tumbler and thoroughly mixed into the shredded cheese. At the other side of the tumbler, extending about 30-60 cm into the tumbler, spray nozzles are situated (S. S. Fogger Tip Assembly #22624-2 80: 80° angle, 2 gal. (8 liters) per hour at 80 PSI (5.3 bar, purchased from Spraying Systems Co. PO Box 95584 Chicago Ill. 60694). The nozzles are able to deliver a fine spray of mist of one of the following natamycin formulations. Two experiments were carried out using either formulation A (reference) or formulation B (present invention).
A) A suspension of Delvocid®, available by DSM Food Specialties USA, by mixing 10 grams of Delvocid® with 4 liters of tapwater.
B) A suspension of Delvocid® and xanthan by mixing 10 grams of Delvocid® with 4 liters of tapwater together with 3 grams Keltrol® RD, available by NutraSweet Kelco Company.

Both suspensions were sprayed on shredded cheese with a flow of 10 liters per hour. The spray characteristics were followed in time during a 2 shift operation, 16 hours per day.

During the tests it was shown that the nozzles could be used with suspension A for a 1-6 hour operation. After this period the nozzles were completely blocked by clogging. The nozzles needed to be cleaned completely before further operation was possible. Using suspension B resulted in a operation of 16 hours without any problems such as clogging.

1. A method for the treatment of a shredded cheese comprising the step of contacting the shredded cheese with an aqueous composition, wherein the aqueous composition comprises a polyene antifungal compound and a thickening agent.

2. The method of claim 1, wherein the polyene antifungal compound comprises natamycin.

3. The method of claim 1, further comprising adding a dry powder composition comprising an anticaking agent to the shredded cheese.

4. The method of claim 3, wherein the dry powder composition is added before the aqueous composition.

5. The method of claim 3 wherein the anticaking agent comprises cellulose or starch or modified starch.

6. The method of claim 1, wherein the thickening agent comprises a xanthan.

7. A processed cheese, wherein the cheese comprises a coating comprising a polyene antifungal compound and a thickening agent.

8. The processed cheese of claim 7, wherein the thickening agent comprises a xanthan.

9. A method for preventing nozzle clogging during the treatment of a food, a feed or agricultural products with an aqueous composition, comprising the step of contacting the food, feed or agricultural product with an aqueous composition comprising a polvene antifungal compound and a thickening agent.

10. The method of claim 9, wherein the food, feed or agricultural product comprises a cheese cheese.

11. The processed cheese of claim 7, wherein the cheese comprises a shredded cheese.

12. The method of claim 10, wherein the cheese comprises a shredded cheese.

13. The method of claim 5, wherein the cellulose comprises a microcrystalline cellulose.

14. A method for the treatment of a food, a feed or an agricultural product comprising the step of contacting the food, feed or agricultural product with an aqueous composition, wherein the aqueous composition comprises a polyene antifungal compound and a thickening agent.

15. A processed food, feed or agricultural product made by a method comprising the step of contacting the food, feed or agricultural product with an aqueous composition, wherein the aqueous composition comprises a polyene antifungal compound and a thickening agent.

16. The processed food, feed or agricultural product of claim 14, wherein the food, feed or agricultural product comprises a cheese.

17. The processed food, feed or agricultural product of claim 15, wherein the cheese comprises a shredded cheese.

18. A processed food, feed or agricultural product, wherein the food, feed or agricultural product comprises a coating comprising a polyene antifungal compound and a thickening agent.

19. The processed food, feed or agricultural product of claim 18, wherein the food, feed or agricultural product comprises a cheese.

20. The processed food, feed or agricultural product of claim 19, wherein the cheese comprises a shredded cheese.

21. The processed food, feed or agricultural product of claim 18, wherein the thickening agent comprises a xanthan.

22. The processed food, feed or agricultural product of claim 18, wherein the coating further comprises an anticaking agent.

23. The processed food, feed or agricultural product of claim 22, wherein the anticaking agent comprises a cellulose, a microcrystalline cellulose, a starch or a modified starch.
